(19) United States
(12) Patent Application Publication
(10) Pub. No.: US 2022/0309936 A1
(43) Pub. Date: Sep. 29, 2022

(54) VIDEO EDUCATION CONTENT PROVIDING METHOD AND APPARATUS BASED ON ARTIFICIAL INTELLIGENCE NATURAL LANGUAGE PROCESSING USING CHARACTERS

(71) Applicant: Transverse Inc., Seongnam (KR)

(72) Inventors: Dayk JANG, Seongnam (KR); Mingu LEE, Seoul (KR); Minseop LEE, Seoul (KR); Minji KANG, Seoul (KR)

(21) Appl. No.: 17/358,896

(22) Filed: Jun. 25, 2021

(30) Foreign Application Priority Data
Mar. 26, 2021 (KR) 10-2021-0040015
Jun. 24, 2021 (KR) 10-2021-0082549

(51) Int. Cl. G09B 5/06; G10L 15/26; G10L 25/63; G06K 9/00

(52) U.S. Cl. CPC G09B 5/065; G10L 15/26; G10L 25/63; G06K 9/00302

(57) ABSTRACT

Disclosed are video education content providing method and apparatus based on artificial intelligence natural language processing using characters. The video education content providing apparatus according to an exemplary embodiment of the present invention may include a participant identification unit which identifies a video education service connection of at least one participant from an external server; a participant information collection unit which acquires video and voice data for each of the at least one participant to collect participant speech information; a speech conversion processing unit that converts the participant speech information into speech text to generate speech analysis information; and a character formation processing unit which creates characters based on the speech analysis information and provides a video education content using the characters to a participant terminal via the external server.

### CROSS-REFERENCE TO RELATED APPLICATIONS

This application claims priority to and the benefit of Korean Patent Application No. 10-2021-0040015 filed in the Korean Intellectual Property Office on Mar. 26, 2021 and Korean Patent Application No. 10-2021-0082549 filed in the Korean Intellectual Property Office on Jun. 24, 2021, the entire contents of which are incorporated herein by reference.

### TECHNICAL FIELD

The present invention relates to video education content providing method and apparatus based on artificial intelligence natural language processing using characters.

### BACKGROUND ART

Contents described in this section merely provide background information on exemplary embodiments of the present invention and do not constitute the related art.

Recently, due to the influence of Corona 19, from the first semester of 2020, most elementary/middle/high school and university classes have been immediately replaced with untact classes. However, according to the survey conducted by the national university student council network by targeting national university students who receive untact classes, 64% or more of respondents did not satisfy the untact classes, and students who responded that the content delivery of online classes was better than that of the contact classes were just 9%.

Currently, real-time untact video education services used in Korea are occupied with a large number of global services, including Zoom, Webex, Google Class, etc., and simply, interchange between teachers and students through video and voice announcement data is just enabled, but a function capable of automatically converting and providing the contents of the video classes into new types of contents has not been disclosed in existing services.

### SUMMARY OF THE INVENTION

The present invention has been made in an effort to provide video education content providing method and apparatus based on artificial intelligence natural language processing using characters in order to solve problems that in untact on-line video education, video education immersion is lowered, and the understanding of a video education content is reduced in participants, particularly, infants and elementary school students who may easily lose interest in an online education environment.

An exemplary embodiment of the present invention provides a video education content providing apparatus including: a participant identification unit which identifies a video education service connection of at least one participant from an external server; a participant information collection unit which acquires video and voice data for each of the at least one participant to collect participant speech information; a speech conversion processing unit that converts the participant speech information into speech text to generate speech analysis information; and a character formation processing unit which creates characters based on the speech analysis information and provides a video education content using the characters to a participant terminal via the external server.

The speech conversion processing unit recognizes the voice speech of the participant included in the participant speech information to convert the voice speech into speech text, applies an artificial intelligence natural language processing function to divide the speech text into questions and answers, and compares the speech text after measuring the cosine similarity to be grouped into a set of the same subject and divided into dialogue chapters to generate the speech analysis information.

The character formation processing unit creates virtual characters with the same number as the number of the at least one participant and outputs the voice speech and text corresponding to the dialogue chapter through the character of each of the at least one participant.

The character formation processing unit analyzes phrases of the dialog chapter to extract a plurality of candidate characters according to the analysis result, analyzes a facial expression or voice of the participant to determine an emotional status, and then selects a character corresponding to the emotional status based on attribute information of each of the plurality of candidate characters, and allows the voice speech and text to be output through the selected character.

The character formation processing unit selects and creates a character matching at least one condition of an age group of the at least one participant, a dialogue keyword, and a dialogue difficulty, and allows the character to be changed in real time by reflecting the facial expression or the body motion of the participant included in the participant's video to the character.

The character formation processing unit calculates a first score based on personal attribute information of at least one of the gender, age and grade of the participant, calculates a second score based on the dialogue keyword, and calculates a final score by summing the first score and the second score, and the character formation processing unit compares the final score with a reference score of each of the plurality of characters to select the character corresponding to the reference score with a smallest difference value from the final score and allows the character to be changed in real time by reflecting the facial expression or the body motion of the participant to the character.

The video education content providing apparatus may further include a declarative sentence content acquisition unit which selects a specific participant of the participants and acquires a declarative sentence content from the selected participant; and a content conversion processing unit which converts the declarative sentence content into a dialogue sentence content in questions and answers or a dialogue format.

The content conversion processing unit divides chapters for each subject by applying an artificial intelligence natural language processing function to the voice or text content of the declarative sentence content and converts the declarative sentence content in the declarative sentence format into the dialogue sentence content in a dialogue format.

The content conversion processing unit collects contents for each chapter for each subject divided based on a natural language processing result obtained by processing the declarative sentence content with a natural language, identifies sequential information for each collected content, and calculates a weight according to importance of the sequential information for each content in which the sequential information is identified, and the content conversion processing unit gives the weight to each content for each chapter for each subject and arranges a content reflected with the weight to convert the arranged content to the dialogue sentence content.

The character formation processing unit creates the character according to the number of dialogue subjects of the dialogue sentence content and allows the voice speech and text corresponding to the dialogue sentence content to be output through the character.

The participant information collection unit acquires gaze concentration detection information on each of the at least one participant, and the character formation processing unit determines a place where the gazes of a plurality of participants are concentrated based on the gaze concentration detection information and adjusts the size or changes the position of a specific character determined as the place where the gaze is concentrated.

Another exemplary embodiment of the present invention provides a video education content providing method including: identifying a video education service connection of at least one participant from an external server; acquiring video and voice data for each of the at least one participant to collect participant speech information; converting the participant speech information into speech text to generate speech analysis information; and creating characters based on the speech analysis information and providing a video education content using the characters to a participant terminal via the external server.

According to the exemplary embodiment of the present invention, the video education content providing apparatus based on artificial intelligence natural language processing using characters converts the voice speech content of participants such as teachers and students in untact video education into text by using a function, applies an artificial STT intelligence natural language processing function to divide the speech text into questions and answers, measures and compares the cosine similarity of the speech text to divide dialogue chapters which is a set of the same subject, and converts the divided dialogue chapters to a dialogue type video education content using characters. Therefore, it is possible to improve the video education immersion and the understanding of the video education contents in participants, particularly, students.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating a video education content providing system based on artificial intelligence natural language processing using characters according to an exemplary embodiment of the present invention.

FIG. 2 is a block diagram schematically illustrating a video education content providing apparatus based on artificial intelligence natural language processing using characters according to an exemplary embodiment of the present invention.

FIG. 3 is a flowchart for describing a video education content providing method based on artificial intelligence natural language processing using characters according to a first exemplary embodiment of the present invention.

FIG. 4 is a flowchart for describing a video education content providing method based on artificial intelligence natural language processing using characters according to a second exemplary embodiment of the present invention.

FIG. 5 is a flowchart for describing a video education content providing method based on artificial intelligence natural language processing using characters according to a third exemplary embodiment of the present invention.

FIG. 6 is an exemplary diagram illustrating a video education content providing operation based on artificial intelligence natural language processing using characters according to a second exemplary embodiment of the present invention.

FIG. 7 is an exemplary diagram illustrating a video education content providing operation based on artificial intelligence natural language processing using characters according to another exemplary embodiment of the present invention.

FIG. 8 is an exemplary diagram illustrating a video education content providing operation based on artificial intelligence natural language processing using characters according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the following description, a detailed explanation of related known configurations or functions may be omitted to avoid obscuring the subject matter of the present invention. Further, hereinafter, the preferred exemplary embodiment of the present invention will be described, but the technical spirit of the present invention is not limited thereto or restricted thereby and the exemplary embodiments can be modified and variously executed by those skilled in the art. Hereinafter, video education content providing method and apparatus based on artificial intelligence natural language processing using characters proposed in the present invention will be described in detail with reference to the accompanying drawings.

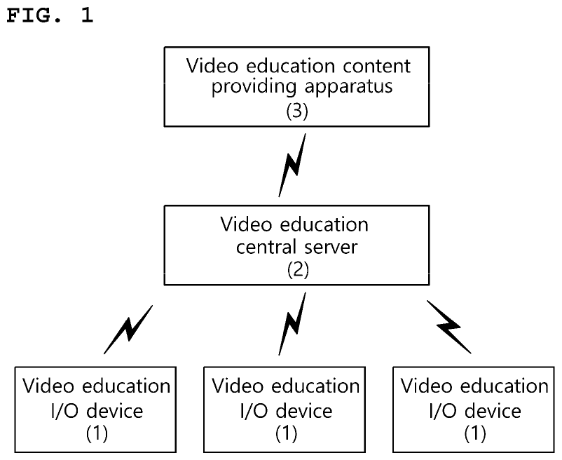

FIG. 1 is a block diagram schematically illustrating a video education content providing system based on artificial intelligence natural language processing using characters according to an exemplary embodiment of the present invention.

The video education content providing system based on artificial intelligence natural language processing using characters according to the exemplary embodiment includes a video education I/O device 1, a video education central server 2, and a video education content providing apparatus 3. The video education content providing system based on artificial intelligence natural language processing using characters of FIG. 1 is in accordance with an exemplary embodiment, and all blocks illustrated in FIG. 1 are not required components, and in another exemplary embodiment, some blocks included in the video education content providing system based on artificial intelligence natural language processing using characters may be added, changed or deleted.

The video education I/O device 1 is formed as a personal device of a participant such as a PC or a smartphone including a microphone and a camera that enables video education participation of each participant.

The video education central server 2 is formed of a video education platform that transmits/receives video and voice data to/from video education I/O devices of each participant and processes instructions.

The video education content providing apparatus 3 receives the video and voice data of the video education central server 2 to convert a voice speech of the participant into text using speech to text (STT), applies an artificial intelligence natural language processing function to divide speech text into questions and answers, and measures and then compares cosine similarity of the speech text to be divided into a dialog chapter that is a set of the same subject.

In addition, the video education content providing apparatus 3 generates a video education content using characters by using the divided dialogue chapter text to provide the generated video education content to the video education I/O device 1 via the video education central server 2. The video education content providing apparatus 3 may generate virtual avatar characters on a screen with the same number as the number of participants and display the divided dialogue chapter with voice speech and text of the avatar character corresponding to each participant.

Hereinafter, an operation of a video education content providing system based on artificial intelligence natural language processing using characters according to a first exemplary embodiment of the present invention will be described.

When the participant participates and speaks in the video education, the video education content providing apparatus 3 converts the participant's speech into text, determines the context of the speech content, divides the speech text into questions and answers by applying an artificial intelligence natural language processing function in which machine learning prior learning capable of dividing the speech into questions and answers is completed, and divides the speech text into dialogue chapters for each subject based on cosine similarity of the speech text. The video education content providing apparatus 3 creates the same number of virtual avatar characters as the number of participants to generate a video education content in which the avatar characters speak or display the voice speech and text of the participants instead of the participants. At this time, the spoken voice of the character may be changed and output to a voice which is the same as or similar to the voice of the participant or a different type of voice from the voice of the participant. Further, the voice speech and the text of the character may be the same content as spoken by the participant or summarized by the video education content providing apparatus 3 by applying the artificial intelligence natural language processing function or may convert subjects, endings, and the like of sentences into expressions of a dialogue format. Furthermore, a type of avatar character created by the video education content providing apparatus 3 or subjects, endings, and the like of voice sentences may be automatically selected to match the age of the participant or the subject of the speech text, and a character's face can be created by modeling a participant's face.

Hereinafter, an operation of a video education content providing system based on artificial intelligence natural language processing using characters according to a second exemplary embodiment of the present invention will be described.

The video education content providing apparatus 3 is characterized in that a participant's face or body is automatically changed and displayed in real time with a different type of character according to an age group of the participant, a keyword of the dialogue, and the like.

When the participant participates and speaks in the video education, the video education content providing apparatus 3 converts the participant's speech into text, determines the context of the speech content, divides the speech text into questions and answers by applying an artificial intelligence natural language processing function in which machine learning prior learning capable of dividing the speech into questions and answers is completed, and divides the speech text into dialogue chapters for each subject based on cosine similarity of the speech text.

The video education content providing apparatus 3 automatically changes and displays a participant's face or body with a different type of character in real time according to an age group of the participant, a keyword of the dialogue, and the like.

For example, when speech text for an animal is detected, the face or body of the participant is changed into a character such as a dog or a cat, and when the age group of the participant is 10 to less than 15 years old, 15 years or older, or the like, a character preferred by the corresponding age group is automatically selected and may be displayed on an on-line video education screen instead of the face or body of the participant.

Hereinafter, an operation of a video education content providing system based on artificial intelligence natural language processing using characters according to a third exemplary embodiment of the present invention will be described.

The video education content providing apparatus 3 applies an artificial intelligence natural language processing function to a voice or text content of a declarative sentence to divide chapters for each subject and converts a declarative sentence type video education content into a dialogue sentence type video education content.

The video education content providing apparatus 3 creates a virtual avatar character on the screen and displays the dialogue sentence type video education content converted from the declarative sentence type video education content with voice speech and text by two or more avatar characters.

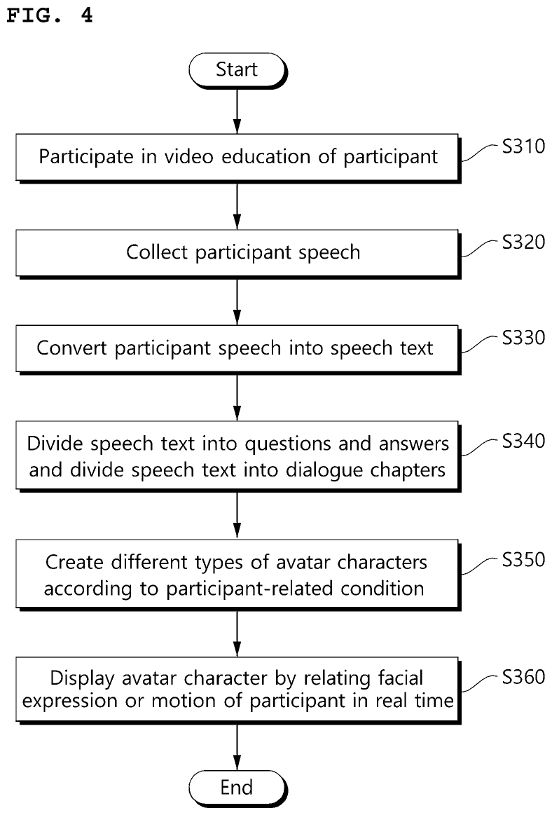

In the third exemplary embodiment of the present invention, as illustrated in FIG. 4, when a declarative sentence type video education content such as one-way lectures, books, and news is input to the video education content providing apparatus 3, an artificial intelligence processor device converts the declarative sentence type content into text, determines the context of the declarative sentence content, converts the declarative sentence type text into dialogue sentence type text by applying an artificial intelligence natural language processing function in which machine learning prior learning capable of converting the speech into a dialogue type sentence corresponding to questions and answers is completed, and divides the dialogue type text into dialogue chapters for each subject based on the cosine similarity of the converted dialogue type text.

The video education content providing apparatus 3 creates two or more virtual avatar characters to generate a video education content in which the avatar characters display the dialogue type text with voice speech or text.

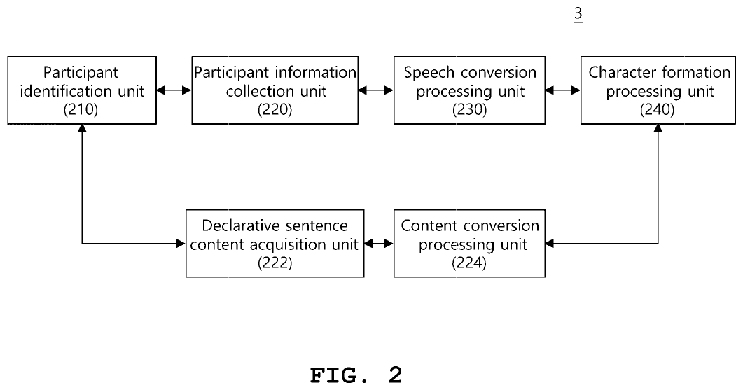

FIG. 2 is a block diagram schematically illustrating a video education content providing apparatus based on artificial intelligence natural language processing using characters according to an exemplary embodiment of the present invention.

The video education content providing apparatus 3 according to the exemplary embodiment includes a participant identification unit 210, a participant information collection unit 220, a speech conversion processing unit 230, a declarative sentence content acquisition unit 222, a content conversion processing unit 224, and a character formation processing unit 240.

The participant identification unit 210 identifies a video education service connection of at least one participant from an external server.

The participant information collection unit 220 acquires video and voice data for each of the at least one participant to collect participant speech information.

The speech conversion processing unit 230 converts the participant speech information into speech text to generate speech analysis information.

The speech conversion processing unit 230 recognizes the voice speech of the participant included in the participant speech information to convert the voice speech into the speech text and applies the artificial intelligence natural language processing function to divide the speech text into questions and answers. Thereafter, the speech conversion processing unit 230 compares the speech text after measuring the cosine similarity to be grouped into a set of the same subject and divided into dialogue chapters to generate the speech analysis information.

The character formation processing unit 240 creates characters based on the speech analysis information and provides a video education content using the characters to the video education I/O device 1 via the video education central server 2.

Hereinafter, an operation of the character formation processing unit 240 according to the first exemplary embodiment will be described.

The character formation processing unit 240 creates the virtual characters with the same number as the number of at least one participant and outputs the voice speech and text corresponding to the dialogue chapter through each character of the at least one participant.

The character formation processing unit 240 analyzes phrases of the dialog chapter to extract a plurality of candidate characters according to the analysis result and analyzes a facial expression or voice of the participant to determine an emotional status, and then selects a character corresponding to the emotional status based on attribute information of each of the plurality of candidate characters. Thereafter, the character formation processing unit 240 allows the voice speech and text to be output through the selected character.

Hereinafter, an operation of the character formation processing unit 240 according to the second exemplary embodiment will be described.

The character formation processing unit 240 selects and creates a character matching at least one condition of an age group of at least one participant, a dialogue keyword, and a dialogue difficulty. The character formation processing unit 240 allows the character to be changed in real time by reflecting the facial expression or the body motion of the participant included in the participant's video to the character.

The character formation processing unit 240 calculates a first score based on personal attribute information of at least one of the gender, age and grade of the participant, calculates a second score based on the dialogue keyword, and calculates a final score by summing the first score and the second score.

The character formation processing unit 240 compares the final score with a reference score of each of the plurality of characters to select a character corresponding to a reference score with a smallest difference value from the final score. The character formation processing unit 240 allows the character to be changed in real time by reflecting the facial expression or the body motion of the participant to the selected character.

Hereinafter, an operation of the character formation processing unit 240 according to the third exemplary embodiment will be described. Here, the character formation processing unit 240 forms characters by interworking with the declarative sentence content acquisition unit 222 and the content conversion processing unit 224.

The declarative sentence content acquisition unit 222 selects a specific participant of the participants and acquires the declarative sentence content from the selected specific participant. Here, the specific participant may be a main participant (e.g., a teacher, a host, etc.) that provides a video education content.

The content conversion processing unit 224 converts the declarative sentence content into a dialogue sentence content in questions and answers or a dialogue format. Specifically, the content conversion processing unit 224 divides chapters for each subject by applying the artificial intelligence natural language processing function to the voice or text content of the declarative sentence content. Thereafter, the content conversion processing unit 224 converts the declarative sentence content in the declarative sentence format into a dialogue sentence content in questions and answers or a dialogue format based on the divided chapters for each subject.

The content conversion processing unit 224 collects contents for each chapter for each subject divided based on a natural language processing result obtained by processing the declarative sentence content with a natural language, identifies sequential information for each collected content, and calculates a weight according to importance of the sequential information for each content in which the sequential information is identified. The content conversion processing unit 224 gives a weight to each content for each chapter for each subject and arranges contents reflected with the weights to convert the arranged contents to the dialogue sentence content.

The character formation processing unit 240 creates the character according to the number of dialogue subjects of the dialogue sentence content and allows the voice speech and text corresponding to the dialogue sentence content to be output through the character.

Meanwhile, when the participant information collection unit 220 acquires gaze concentration detection information on each of at least one participant, the character formation processing unit 240 may perform the following operation. Here, the gaze concentration detection information refers to information collected from each of the video education I/O devices 1 and means information of detecting a position on which the participant's gazes stay.

The character formation processing unit 240 determines a place where the gazes of a plurality of participants are concentrated based on the gaze concentration detection information and may adjust the size of a specific character determined as the place where the gaze is concentrated.

Specifically, the character formation processing unit 240 may adjust the size of the specific character determined as the place where the gaze is concentrated to be larger than the sizes of the remaining characters except for the specific character. In addition, the character formation processing unit 240 may adjust the position or arrangement of the plurality of characters so that the specific character is positioned at the center or the top of the screen while adjusting the size of the specific character.

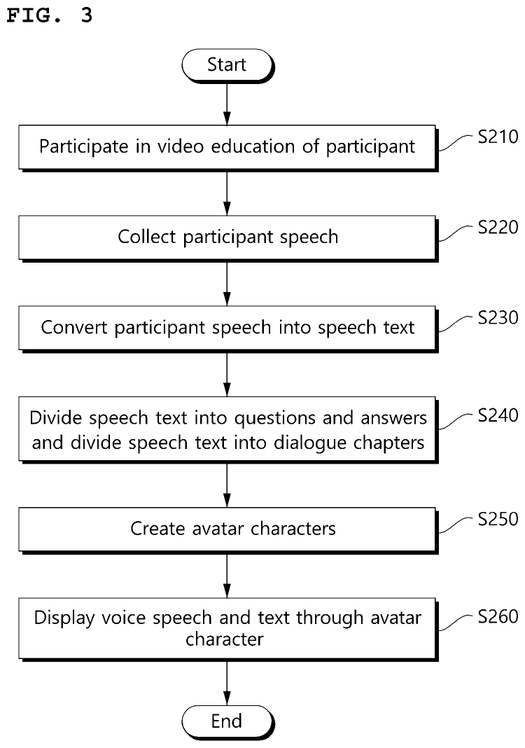

FIG. 3 is a flowchart for describing a video education content providing method based on artificial intelligence natural language processing using characters according to a first exemplary embodiment of the present invention.

The video education content providing apparatus 3 identifies a video education service connection of at least one participant from an external server (S210).

The video education content providing apparatus 3 acquires video and voice data for each of the at least one participant to collect participant speech information (S220).

The video education content providing apparatus 3 converts participant's speech into speech text (S230) and generates speech analysis information by performing the question and answer division and the dialogue chapter division of the speech text (S240). The video education content providing apparatus 3 recognizes the voice speech of the participant included in the participant speech information to convert the voice speech into the speech text and applies the artificial intelligence natural language processing function to divide the speech text into questions and answers.

The video education content providing apparatus 3 creates characters based on the speech analysis information (S250).

The video education content providing apparatus 3 displays the voice speech and text through the generated characters to provide a video education content using the characters to the video education I/O device 1 via the video education central server 2 (S260).

FIG. 4 is a flowchart for describing a video education content providing method based on artificial intelligence natural language processing using characters according to a second exemplary embodiment of the present invention.

The video education content providing apparatus 3 identifies a video education service connection of at least one participant from an external server (S310).

The video education content providing apparatus 3 acquires video and voice data for each of the at least one participant to collect participant speech information (S320).

The video education content providing apparatus 3 converts participant speech into speech text (S330), and generates speech analysis information by performing the question and answer division and the dialogue chapter division of the speech text (S340). The video education content providing apparatus 3 recognizes the voice speech of the participant included in the participant speech information to convert the voice speech into the speech text and applies the artificial intelligence natural language processing function to divide the speech text into questions and answers.

The video education content providing apparatus 3 creates different types of characters according to participant-related conditions (S350). The video education content providing apparatus 3 selects and creates a character matching at least one condition of an age group of at least one participant, a dialogue keyword, and a dialogue difficulty.

The video education content providing apparatus 3 displays a character by reflecting the expression or motion of the participant in real time (S360). The video education content providing apparatus 3 allows the character to be changed in real time by reflecting the facial expression or the body motion of the participant included in the participant's video to the character.

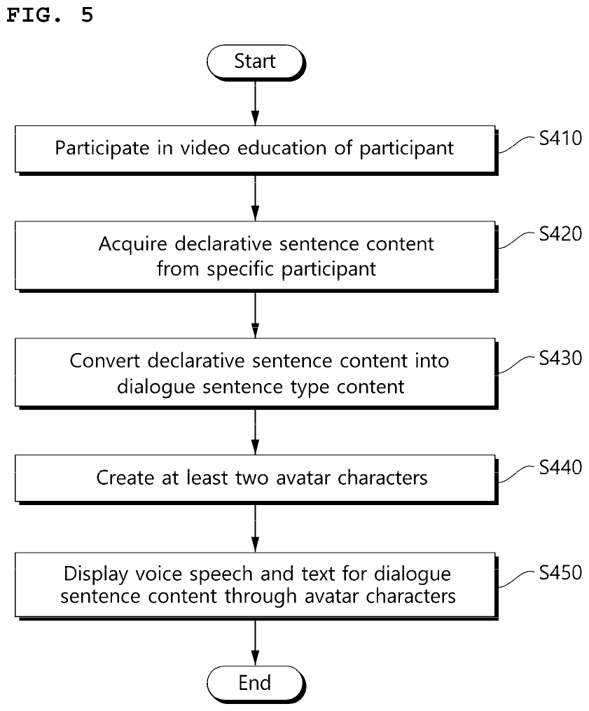

FIG. 5 is a flowchart for describing a video education content providing method based on artificial intelligence natural language processing using characters according to a third exemplary embodiment of the present invention.

The video education content providing apparatus 3 identifies a video education service connection of at least one participant from an external server (S410).

The video education content providing apparatus 3 acquires a declarative sentence content from a specific participant (S420). Here, the specific participant may be a main participant (e.g., a teacher, a host, etc.) that provides a video education content.

The video education content providing apparatus 3 converts the declarative sentence content into a dialogue sentence content in questions and answers or a dialogue format (S430). Specifically, the video education content providing apparatus 3 divides chapters for each subject by applying an artificial intelligence natural language processing function to a voice or text content of the declarative sentence content and converts a declarative sentence content in a declarative sentence format into a dialogue sentence content of questions and answers or dialogue format based on the divided chapter for each subject.

The video education content providing apparatus 3 creates at least two characters (S440) and displays voice speech and text for the dialogue sentence content through the created characters (S450). The video education content providing apparatus 3 creates characters according to the number of dialogue subjects of the dialogue sentence content and allows the voice speech and text corresponding to the dialogue sentence content to be output through the characters.

In each of FIGS. 3 to 5, each step is described to be sequentially executed, but it is not necessarily limited thereto. In other words, since it is applicable to change and execute the steps described in each of FIGS. 3 to 5 or execute one or more steps in parallel, each of FIGS. 3 to 5 is not limited to a time sequential order.

The video education content providing method according to the exemplary embodiment described in each of FIGS. 3 to 5 may be implemented in an application (or program) and may be recorded on a recording medium that can be read with a terminal device (or a computer). The recording medium which records the application (or program) for implementing the video education content providing method according to the present exemplary embodiment and can be read by the terminal device (or computer) includes all types of recording devices or media in which data capable of being read by a computing system is stored.

The video education content providing operation based on artificial intelligence natural language processing using characters according to the first exemplary embodiment of the present invention will be described below in more detail.

When the participant participates and speaks in the video education, the video education content providing apparatus 3 converts the participant's speech into text, determines the context of the speech content, divides the speech text into questions and answers by applying an artificial intelligence natural language processing function in which machine learning prior learning capable of dividing the speech into questions and answers is completed, and divides the speech text into dialogue chapters for each subject based on cosine similarity of the speech text. The video education content providing apparatus 3 creates the same number of virtual avatar characters as the number of participants to generate a video education content in which the avatar characters speak or display the voice speeches and texts of the participants instead of the participants. At this time, the spoken voice of the character may be changed and output to a voice which is the same as or similar to the voice of the participant or a different type of voice from the voice of the participant. Further, the voice speeches and the text of the character may be the same content as spoken by the participant or summarized by the video education content providing apparatus 3 by applying the artificial intelligence natural language processing function or may convert subjects, endings, and the like of sentences into expressions of a dialogue sentence format. Furthermore, a type of avatar characters created by the video education content providing apparatus 3 or subjects, endings, and the like of voice sentences may be automatically selected to match the age of the participant or the subject of the speech text, and a character's face may be created by modeling a participant's face.

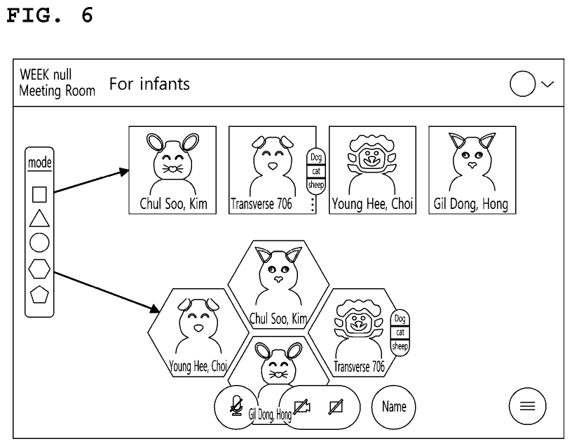

FIG. 6 is an exemplary diagram illustrating a video education content providing operation based on artificial intelligence natural language processing using characters according to a second exemplary embodiment of the present invention.

Referring to FIG. 6, the video education content providing apparatus 3 is characterized in that a participant's face or body is automatically changed and displayed in real time with a different type of character according to an age group of the participant, a keyword of the dialogue, and the like.

When the participant participates and speaks in the video education, the video education content providing apparatus 3 converts the participant's speech into text, determines the context of the speech content, divides the speech text into questions and answers by applying an artificial intelligence natural language processing function in which machine learning prior learning capable of dividing the speech into questions and answers is completed, and divides the speech text into dialogue chapters for each subject based on cosine similarity of the speech text.

The video education content providing apparatus 3 automatically changes and displays a participant's face or body with a different type of character in real time according to an age group of the participant, a keyword of the dialogue, and the like.

For example, as illustrated in FIG. 6, when speech text for an animal is detected, the face or body of the participant is changed into a character such as a dog or a cat, and when the age group of the participant is 10 to less than 15 years old, 15 years or older, or the like, a character preferred by the corresponding age group is automatically selected and may be displayed on a video education screen instead of the face or body of the participant.

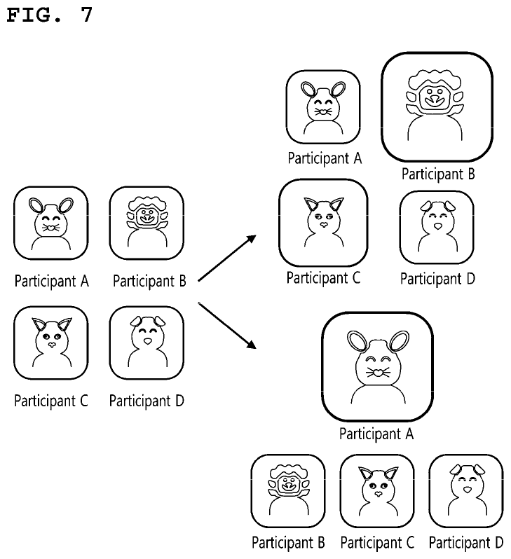

FIG. 7 is an exemplary diagram illustrating a video education content providing operation based on artificial intelligence natural language processing using characters according to another exemplary embodiment of the present invention.

When the video education content providing apparatus 3 acquires the gaze concentration detection information for each of the at least one participant, the video education content providing apparatus 3 may perform the operation as illustrated in FIG. 7.

The video education content providing apparatus 3 determines a place where the gazes of a plurality of participants are concentrated based on gaze concentration detection information and may control the size or position of a specific character determined as the place where the gaze is concentrated.

For example, referring to FIG. 7, when the place where the gaze is concentrated is determined as a character of Participant B, the video education content providing apparatus 3 may adjust the size of Character B to be larger than the sizes of remaining characters (Characters A, C, and D) except for Character B.

Meanwhile, when the place where the gaze is concentrated is determined as a character of Participant A, the video education content providing apparatus 3 may adjust positions or arrangement of a plurality of characters so that Character A is positioned at the center or the top of the screen while adjusting the size of Character A.

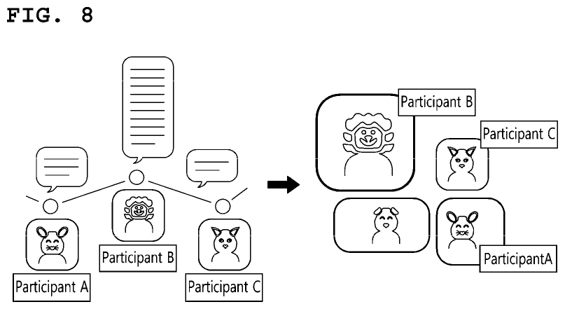

FIG. 8 is an exemplary diagram illustrating a video education content providing operation based on artificial intelligence natural language processing using characters according to another exemplary embodiment of the present invention.

The video education content providing apparatus 3 analyzes participant speech information for each of the at least one participant and may perform the operation as illustrated in FIG. 8 according to a speech degree.

The video education content providing apparatus 3 determines the speech degree of each participant based on the speech analysis information generated by converting the participant speech information into the speech text and may adjust the size of the specific character according to the speech degree.

For example, referring to FIG. 8, when the character of which the speech degree is large is determined as a character of Participant B, the video education content providing apparatus 3 may adjust the size of Character B to be larger than the sizes of remaining characters (Characters A, C, and D) except for Character B.

On the other hand, the video education content providing apparatus 3 may adjust the sizes of all characters according to the speech degree and may arrange the characters adjusted to different sizes sequentially or randomly.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A video education content providing apparatus based on artificial intelligence natural language processing using characters as an apparatus for providing a video education content which is untactly performed between participants, the video education content providing apparatus comprising:
a participant identification unit which identifies a video education service connection of at least one participant from an external server;
a participant information collection unit which acquires video and voice data for each of the at least one participant to collect participant speech information;
a speech conversion processing unit that converts the participant speech information into speech text to generate speech analysis information; and
a character formation processing unit which creates characters based on the speech analysis information and provides a video education content using the characters to a participant terminal via the external server.

2. The video education content providing apparatus of claim 1, wherein the speech conversion processing unit recognizes the voice speech of the participant included in the participant speech information to convert the voice speech into speech text, applies an artificial intelligence natural language processing function to divide the speech text into questions and answers, compares the speech text after measuring a cosine similarity to be grouped into a set of the same subject and divided into dialogue chapters to generate the speech analysis information.

3. The video education content providing apparatus of claim 2, wherein the character formation processing unit creates virtual characters with the same number as the number of the at least one participant and outputs the voice speech and text corresponding to the dialogue chapter through the character of each of the at least one participant.

4. The video education content providing apparatus of claim 3, wherein the character formation processing unit analyzes phrases of the dialog chapter to extract a plurality of candidate characters according to the analysis result, analyzes a facial expression or voice of the participant to determine an emotional status, and then selects a character corresponding to the emotional status based on attribute information of each of the plurality of candidate characters, and allows the voice speech and text to be output through the selected character.

5. The video education content providing apparatus of claim 2, wherein the character formation processing unit selects and creates a character matching at least one condition of an age group of the at least one participant, a dialogue keyword, and a dialogue difficulty, and allows the character to be changed in real time by reflecting a facial expression or a body motion of the participant included in the participant's video to the character.

6. The video education content providing apparatus of claim 5, wherein the character formation processing unit calculates a first score based on personal attribute information of at least one of gender, age, and grade of the participant, calculates a second score based on the dialogue keyword, and calculates a final score by summing the first score and the second score, and
the character formation processing unit compares the final score with a reference score of each of a plurality of characters to select the character corresponding to the reference score with a smallest difference value from the final score and allows the character to be changed in real time by reflecting the facial expression or the body motion of the participant to the character.

7. The video education content providing apparatus of claim 1, further comprising:
a declarative sentence content acquisition unit which selects a specific participant of the participants and acquires a declarative sentence content from the selected participant; and
a content conversion processing unit which converts the declarative sentence content into a dialogue sentence content in questions and answers or a dialogue format.

8. The video education content providing apparatus of claim 7, wherein the content conversion processing unit divides chapters for each subject by applying an artificial intelligence natural language processing function to a voice or text content of the declarative sentence content and converts the declarative sentence content in a declarative sentence format into the dialogue sentence content in the questions and answers or the dialogue format.

9. The video education content providing apparatus of claim 8, wherein the content conversion processing unit collects contents for each chapter for each subject divided based on a natural language processing result obtained by processing the declarative sentence content with a natural language, identifies sequential information for each collected content, and calculates a weight according to importance of the sequential information for each content in which the sequential information is identified, and
the content conversion processing unit gives the weight to each content for each chapter for each subject and arranges a content reflected with the weight to convert the arranged content to the dialogue sentence content.

10. The video education content providing apparatus of claim 9, wherein the character formation processing unit creates the character according to the number of dialogue subjects of the dialogue sentence content and allows voice speech and text corresponding to the dialogue sentence content to be output through the character.

11. The video education content providing apparatus of claim 1, wherein the participant information collection unit acquires gaze concentration detection information on each of the at least one participant, and
the character formation processing unit determines a place where gazes of a plurality of participants are concentrated based on the gaze concentration detection information and adjusts a size or changes a position of a specific character determined as the place where the gaze is concentrated.

12. A video education content providing method based on artificial intelligence natural language processing using characters as a method for providing a video education content which is untactly performed between participants by a video education content providing apparatus, the video education content providing method comprising the steps of:
identifying a video education service connection of at least one participant from an external server;
acquiring video and voice data for each of the at least one participant to collect participant speech information;
converting the participant speech information into speech text to generate speech analysis information; and
creating characters based on the speech analysis information and providing a video education content using the characters to a participant terminal via the external server.
